(19) United States
(12) Patent Application Publication
(10) Pub. No.: US 2022/0067881 A1
(43) Pub. Date: Mar. 3, 2022

(54) IMAGE CORRECTION METHOD AND SYSTEM BASED ON DEEP LEARNING

(71) Applicant: INDUSTRIAL TECHNOLOGY RESEARCH INSTITUTE, Hsinchu (TW)

(72) Inventors: Guan-De LI, Tainan City (TW); Ming-Jia HUANG, Taichung City (TW); Hung-Hsuan LIN, Zhubei City (TW); Yu-Je LI, New Taipei City (TW); Chia-Ling LO, Taichung City (TW)

(73) Assignee: INDUSTRIAL TECHNOLOGY RESEARCH INSTITUTE, Hsinchu (TW)

(21) Appl. No.: 17/104,781

(22) Filed: Nov. 25, 2020

(30) Foreign Application Priority Data
Aug. 26, 2020 (TW) 109129193

(51) Int. Cl. G06T 3/60; H04N 5/232; G06T 7/73

(52) U.S. Cl. CPC G06T 3/60; H04N 5/23229; G06T 2207/30208; G06T 2207/20081; G06T 7/73

(57) ABSTRACT

An image correction method and an image correction system based on deep learning are provided. The image correction method includes the following steps. An image containing at least one character is received by a deep learning model, and a perspective transformation matrix is generated according to the image. A perspective transformation is performed on the image according to the perspective transformation matrix to obtain a corrected image containing a front view of the at least one character. An optimized corrected image containing the front view of the at least one character is generated according to the image. An optimized perspective transformation matrix corresponding to the image and the optimized corrected image is obtained. A loss value between the optimized perspective transformation matrix and the perspective transformation matrix is calculated. The deep learning model is updated using the loss value.

This application claims the benefit of Taiwan application Serial No. 109129193, filed Aug. 26, 2020, the disclosure of which is incorporated by reference herein in its entirety.

### TECHNICAL FIELD

The disclosure relates in general to an image correction method and system, and more particularly to an image correction method and system based on deep learning.

### BACKGROUND

In the field of image recognition, particularly the recognition of character in an image, a local image containing the target character is firstly located from the image and then is corrected as a front view image for the subsequent recognition model to perform character recognition. An image correction procedure converts the images with different view angles and distances into front view images with the same angle and distance to speed up the learning of the recognition model and increase the recognition accuracy.

However, in the current technology, the image correction procedure still depends on the conventional image processing method to manually find the rotation parameters and repeatedly adjust the parameters to increase the accuracy of the image correction procedure. Although the image correction procedure can be performed using the technology of artificial intelligence (AI), the image correction procedure can only find clockwise or anticlockwise rotation angles and cannot be used in complicated image processing to scale, sift or tilt the image.

Therefore, it has become a prominent task for the industries to efficiently and correctly correct various images as front view images.

### SUMMARY

The disclosure is directed to an image correction method and a system based on deep learning. The perspective transformation parameters for the image correction procedure are found by a deep learning model and used to efficiently correct various images to front view images and further update the deep learning model using the loss value to increase the recognition accuracy.

According to one embodiment, an image correction method based on deep learning is provided. The image correction method includes the following steps. An image containing at least one character is received by a deep learning model, and a perspective transformation matrix is generated according to the image. A perspective transformation on the image is performed according to the perspective transformation matrix, and a corrected image containing a front view of the at least one character is obtained. An optimized corrected image containing the front view of the at least one character is generated according to the image. An optimized perspective transformation matrix corresponding to the image and the optimized corrected image is obtained. A loss value between the optimized perspective transformation matrix and the perspective transformation matrix is calculated. The deep learning model is updated using the loss value.

According to another embodiment, an image correction system based on deep learning is provided. The image correction system includes a deep learning model, a processing unit and a model adjustment unit. The deep learning model is configured to receive an image containing at least one character and generate a perspective transformation matrix according to the image. The processing unit is configured to receive the image and the perspective transformation matrix and perform a perspective transformation on the image according to the perspective transformation matrix to obtain a corrected image containing a front view of the at least one character. The model adjustment unit is configured to receive the image, generate an optimized corrected image containing the front view of the at least one character according to the image, obtain an optimized perspective transformation matrix corresponding to the image and the optimized corrected image, calculate a loss value between the optimized perspective transformation matrix and the perspective transformation matrix, and update the deep learning model using the loss value.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of an image correction system based on deep learning according to an embodiment of the present disclosure;

FIG. 2 is a flowchart of an embodiment an image correction method based on deep learning according to the present disclosure;

FIG. 3 is a schematic diagram of an image containing a vehicle plate according to an embodiment of the present disclosure;

FIG. 4 is a schematic diagram of an image containing a road sign according to another embodiment of the present disclosure;

FIG. 5 is a schematic diagram of a corrected image according to an embodiment of the present disclosure;

FIG. 6 is a flowchart of sub-steps of step S130 according to an embodiment of the present disclosure;

FIG. 7 is a schematic diagram of an image containing marks according to an embodiment of the present disclosure;

FIG. 8 is a schematic diagram of an image and an extended image according to an embodiment of the present disclosure;

FIG. 9 is a schematic diagram of an optimized corrected image according to an embodiment of the present disclosure;

FIG. 10 is a schematic diagram of an image correction system based on deep learning according to an embodiment of the present disclosure; and

FIG. 11 is a flowchart of an image correction method based on deep learning according to another embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

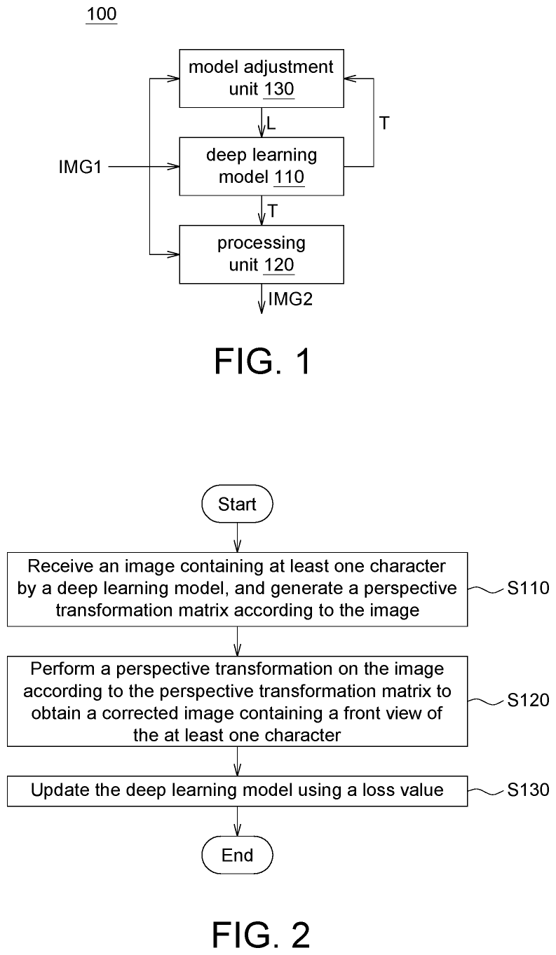

Referring to FIG. 1, a schematic diagram of an image correction system 100 based on deep learning according to an embodiment of the present disclosure is shown. The image correction system 100 includes a deep learning model 110, a processing unit 120 and a model adjustment unit 130. The deep learning model 110 can be realized by a convolutional neural network (CNN) model. The processing unit 120 and the model adjustment unit 130 can be realized by a chip, a circuit board or a circuit.

Refer to FIG. 1 and FIG. 2 at the same time. FIG. 2 is a flowchart of an embodiment an image correction method based on deep learning according to the present disclosure.

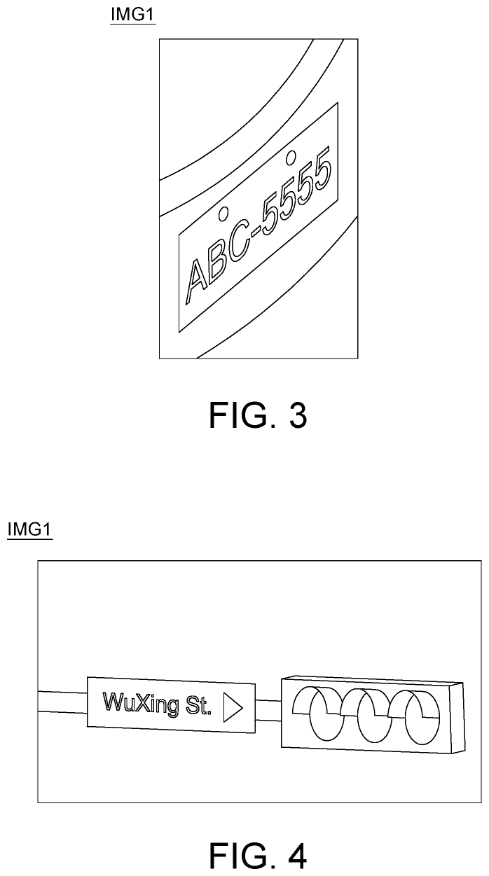

In step S110, an image IMG1 containing at least one character is received by the deep learning model 110, and a perspective transformation matrix T is generated according to the image IMG1. The image IMG1 can be any image containing at least one character, such as the image of a vehicle plate, a road sign, a serial number or a sign board. The at least one character is such as number, English character, hyphen, punctuation mark or a combination thereof. Refer to FIG. 3 and FIG. 4. FIG. 3 is a schematic diagram of an image IMG1 containing a vehicle plate according to an embodiment of the present disclosure. As indicated in FIG. 3, the image IMG1 contains characters “ABC-5555”. FIG. 4 is a schematic diagram of an image IMG1 containing a road sign according to another embodiment of the present disclosure. As indicated in FIG. 4, the image IMG1 contains characters “WuXing St.”. The deep learning model 110 is a pre-trained model, and when the image IMG1 is inputted to the deep learning model 110, the deep learning model 110 correspondingly outputs the perspective transformation matrix T corresponding to the image IMG1. The perspective transformation matrix T contains several perspective transformation parameters T₁₁, T₁₂, T₁₃, T₂₁, T₂₂, T₂₃, T₃₁, T₃₂ and 1 as indicated in formula 1.

$$T = [ \begin{matrix}{T}_{11} & {T}_{12} & {T}_{13} \\ {T}_{21} & {T}_{22} & {T}_{23} \\ {T}_{31} & {T}_{32} & 1\end{matrix} ] \qquad ( formula 1 )$$

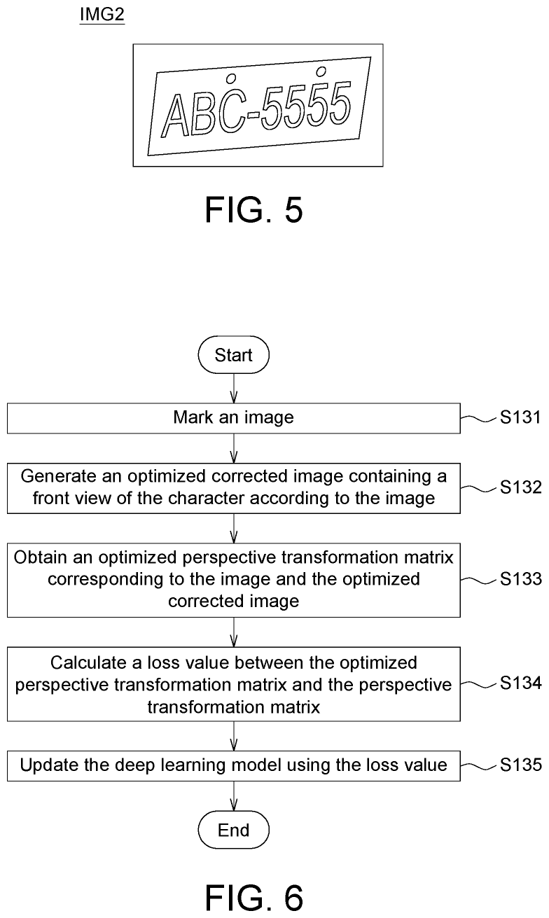

In step S120, a perspective transformation is performed on the image IMG1 by the processing unit 120 according to the perspective transformation matrix T to obtain a corrected image IMG2 containing a front view of the at least one character. The processing unit 120 performs the perspective transformation on the image IMG1 according to the perspective transformation matrix T to convert the image IMG1 into the corrected image IMG2 containing the front view of the at least one character. Referring to FIG. 5, a schematic diagram of a corrected image IMG2 according to an embodiment of the present disclosure is shown. Let the image IMG1 of FIG. 3 be taken for example. The image IMG1 contains a vehicle plate. After the perspective transformation is performed on the image IMG1 according to the perspective transformation matrix T, the corrected image IMG2 as indicated in FIG. 5 can be obtained.

In step S130, the deep learning model 110 is updated by the model adjustment unit 130 using a loss value L. Referring to FIG. 6, a flowchart of sub-steps of step S130 according to an embodiment of the present disclosure is shown. The step S130 includes steps S131 to S135.

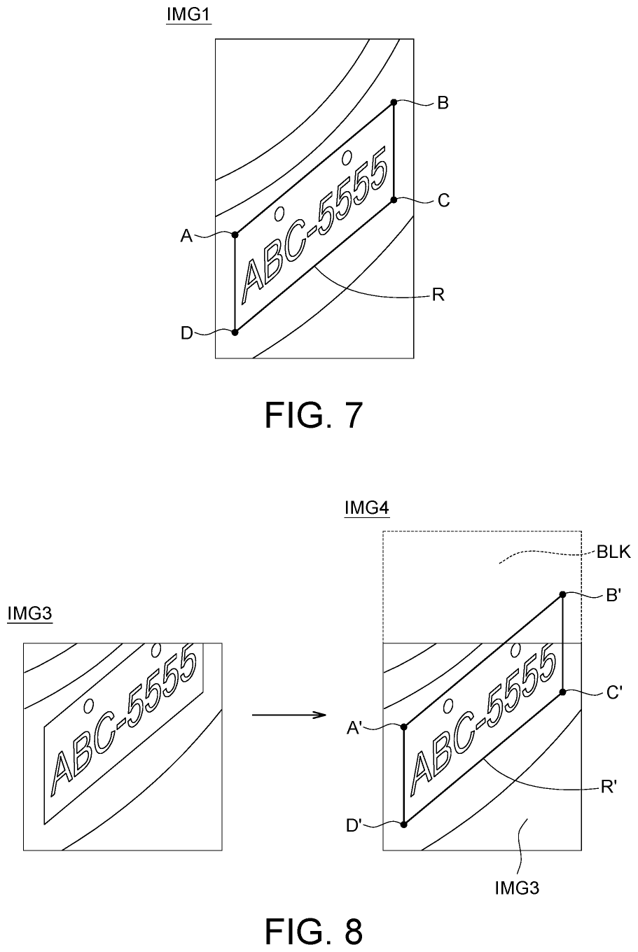

In step S131, the image IMG1 is marked by the model adjustment unit 130, wherein the mark contains a mark range covering the character. Referring to FIG. 7, a schematic diagram of an image IMG1 containing marks according to an embodiment of the present disclosure. The marks on the image IMG1 include mark points A, B, C and D, which form a mark range R covering the character. In the present embodiment, the image IMG1 is an image containing a vehicle plate, the mark points A, B, C and D can be located at the four corners of the vehicle plate, and the mark range R is a quadrilateral. In another embodiment, if the image IMG1 is an image containing a road sign as indicated in FIG. 4 and the mark points A, B, C and D can be located at the four corners of the road sign, then the mark range is a quadrilateral. In another embodiment, if the character in the image IMG1 is not located on a geometric object such as a vehicle plate or a road sign, then the model adjustment unit 130 only needs to enable the mark range to cover the character. In another embodiment, the model adjustment unit 130 can directly receive a marked image but does not perform the marks.

Referring to FIG. 8, a schematic diagram of an image IMG3 and an extended image IMG4 according to an embodiment of the present disclosure is shown. In an embodiment, if the mark range cannot cover the character in the image IMG3 or the character in the image IMG3 exceeds the image IMG3, then the model adjustment unit 130 extends the image IMG3 to obtain an extended image IMG4 and marks the extended image IMG4, such that the mark range R′ can cover the character. In the present embodiment, the model adjustment unit 130 adds a blank image BLK to the image IMG3 to obtain the extended image IMG4.

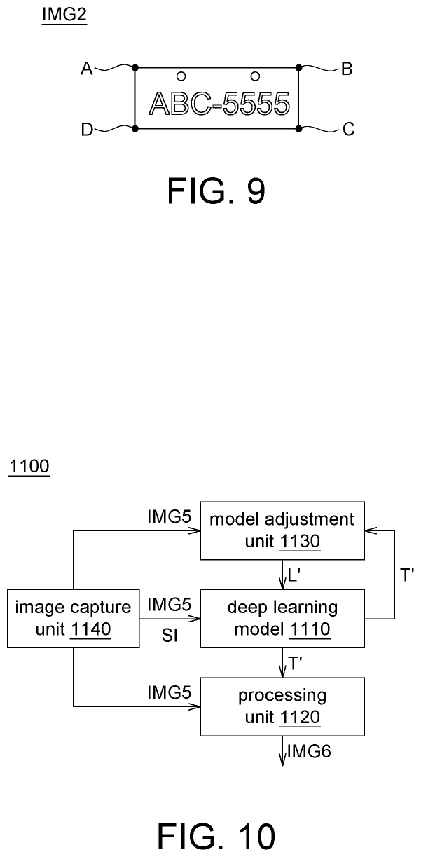

Refer to FIG. 7 again. In step S132, an optimized corrected image containing a front view of the character is generated by the model adjustment unit 130 according to the image IMG1. In the present embodiment, the model adjustment unit 130 aligns the pixels at the mark points A, B, C and D of the image IMG1 to the four corners of the image to obtain the optimized corrected image. Referring to FIG. 9, a schematic diagram of an optimized corrected image according to an embodiment of the present disclosure is shown. As indicated in FIG. 9, the optimized corrected image contains the front view of the character.

In step S133, an optimized perspective transformation matrix corresponding to the image IMG1 and the optimized corrected image is obtained by the model adjustment unit 130. Due to the perspective transformation relation between the image IMG1 and the optimized corrected image, the model adjustment unit 130 can calculate a perspective transformation matrix using the image IMG1 and the optimized corrected image and use the calculated perspective transformation matrix as the optimized perspective transformation matrix.

In step S134, a loss value L between the optimized perspective transformation matrix and the perspective transformation matrix T is calculated by the model adjustment unit 130. In step S135, the deep learning model 110 is updated by the model adjustment unit 130 using the loss value L. As indicated in FIG. 5, since the corrected image IMG2 obtained by performing a perspective transformation on the image IMG1 according to the perspective transformation matrix T does not match a best result, the deep learning model 110 can be updated by the model adjustment unit 130 using the loss value L.

According to the image correction system 100 and method based on deep learning of the present disclosure, the perspective transformation parameters for the image correction procedure are found by a deep learning model and used to efficiently correct various images to front view images and further update the deep learning model using the loss value to increase the recognition accuracy.

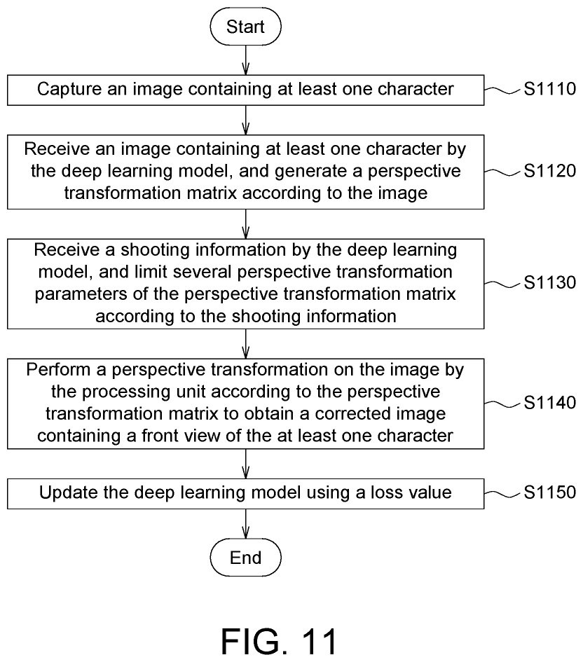

Referring to FIG. 10, a schematic diagram of an image correction system 1100 based on deep learning according to an embodiment of the present disclosure is shown. The image correction system 1100 is different from the image correction system 100 in that the image correction system 1100 further includes an image capture unit 1140, which can be realized by a camera. Refer to FIG. 10 and FIG. 11 at the same time. FIG. 11 is a flowchart of an image correction method based on deep learning according to another embodiment of the present disclosure.

In step S1110, an image IMG5 containing at least one character is captured by the image capture unit 1140.

In step S1120, an image IMG5 is received by the deep learning model 1110, and a perspective transformation matrix T′ is generated according to the image IMG5. Step S1120 is similar to step S110 of FIG. 2, and the similarities are not repeated here.

In step S1130, a shooting information SI is received by the deep learning model 1110, and several perspective transformation parameters of the perspective transformation matrix T′ are limited according to the shooting information SI. The shooting information SI is a shooting location, a shooting direction and a shooting angle. The shooting location, the shooting direction and the shooting angle can respectively be represented by 3 parameters, 2 parameters and 1 parameter. The perspective transformation matrix T′ contains several perspective transformation parameters T′₁₁, T′₁₂, T₁₃, T′₂₁, T′₂₂, T′₂₃, T′₃₁, T′₃₂ and 1 as indicated in formula 2. The perspective transformation parameters T′₁₁, T′₁₂, T′₁₃, T′₂₁, T′₂₂, T′₂₃, T′₃₁, T′₃₂ can be determined according to the 6 parameters of the shooting location, the shooting direction and the shooting angle.

$$T ' = [ \begin{matrix}{T}_{11}^{′} & {T}_{12}^{′} & {T}_{13}^{′} \\ {T}_{21}^{′} & {T}_{22}^{′} & {T}_{23}^{′} \\ {T}_{31}^{′} & {T}_{32}^{′} & 1\end{matrix} ] \qquad ( formula 2 )$$

Firstly, the deep learning model 1110 assigns a reasonable range to each of the 6 parameters of the shooting location, the shooting direction and the shooting angle and calculates the perspective transformation parameter T′ₘₙ using a grid search algorithm to obtain a largest value Lₘₙ and a smallest value Sₘₙ of the perspective transformation parameter Tₘₙ Then, the deep learning model 1110 calculates each perspective transformation parameter T′ₘₙ according to formula 3:

T′ₘₙ=Sₘₙ+(Lₘₙ−Sₘₙ)σ(Zₘₙ) (formula 3)

Wherein Zₘₙ is a value not subjected to any restrictions, and a is a logic function whose range is 0 to 1. Thus, the deep learning model 1110 can assure that each of the perspective transformation parameters T′₁₁, T′₁₂, T′₁₃, T′₂₁, T′₂₂, T′₂₃, T′₃₁, T′₃₂ falls within a reasonable range.

In step S1140, a perspective transformation is performed on the image IMG5 by the processing unit 1120 according to the perspective transformation matrix T′ to obtain a corrected image IMG6 containing a front view of the at least one character. Step S1140 is similar to step S120 of FIG. 2, and the similarities are not repeated here.

In step S1150, the deep learning model 1110 is updated using a loss value L′. Step S1150 is similar to step S130 of FIG. 2, and the similarities are not repeated here.

Thus, the image correction system 1100 and method based on deep learning of the present disclosure can limit the range of the perspective transformation parameter according to the shooting information SI to increase the accuracy of the deep learning model 1110 and make the training of the deep learning model 1110 easier.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An image correction method based on deep learning, comprising:
receiving an image containing at least one character by a deep learning model, and generating a perspective transformation matrix according to the image;
performing a perspective transformation on the image according to the perspective transformation matrix to obtain a corrected image containing a front view of the at least one character;
generating an optimized corrected image containing the front view of the at least one character according to the image;
obtaining an optimized perspective transformation matrix corresponding to the image and the optimized corrected image;
calculating a loss value between the optimized perspective transformation matrix and the perspective transformation matrix; and
updating the deep learning model using the loss value.

2. The image correction method according to claim 1, wherein the step of generating the optimized corrected image containing the front view of the at least one character according to the image comprises:
marking the image containing a mark range covering the at least one character.

3. The image correction method according to claim 2, further comprising:
when the mark range cannot cover the at least one character, extending the image to obtain an extended image; and
marking the extended image, such that the mark range covers the at least one character.

4. The image correction method according to claim 1, further comprising:
capturing the image by an image capture unit; and
limiting a plurality of perspective transformation parameters of the perspective transformation matrix according to a shooting information of the image capture unit.

5. The image correction method according to claim 4, wherein the shooting information comprises a shooting location, a shooting direction and a shooting angle.

6. An image correction system based on deep learning, comprising:
a deep learning model configured to receive an image containing at least one character, and generate a perspective transformation matrix according to the image;
a processing unit configured to receive the image and the perspective transformation matrix, and perform a perspective transformation on the image according to the perspective transformation matrix to obtain a corrected image containing a front view of the at least one character; and
a model adjustment unit configured to receive the image, generate an optimized corrected image containing the front view of the at least one character according to the image, obtain an optimized perspective transformation matrix corresponding to the image and the optimized corrected image, calculate a loss value between the optimized perspective transformation matrix and the perspective transformation matrix, and update the deep learning model using the loss value.

7. The image correction system according to claim 6, wherein the model adjustment unit further marks the image containing a mark range covering the at least one character.

8. The image correction system according to claim 7, wherein when the mark range cannot cover the at least one character, the model adjustment unit further extends the image to obtain an extended image and marks the extended image, such that the mark range covers the at least one character.

9. The image correction system according to claim 6, further comprising:
an image capture unit configured to capture the image;
wherein the processing unit limits a plurality of perspective transformation parameters of the perspective transformation matrix according to a shooting information of the image capture unit.

10. The image correction system according to claim 9, wherein the shooting information comprises a shooting location, a shooting direction and a shooting angle.
